(19) United States
(12) Patent Application Publication
(10) Pub. No.: US 2009/0309405 A1
(43) Pub. Date: Dec. 17, 2009

(54) CHILD SAFETY SEAT WITH ADJUSTABLE HEADREST

(75) Inventor: Wieslaw Maciejczyk, Victoria (AU)

Correspondence Address: ADAMS INTELLECTUAL PROPERTY LAW, Suite 2350 Charlotte Plaza, 201 South College Street, CHARLOTTE, NC, 28244, US

(73) Assignee: BRITAX CHILDCARE PTY LTD, Victoria (AU)

(21) Appl. No.: 11/573,504

(22) PCT Filed: Aug. 10, 2005
(86) PCT No.: PCT/AU2005/001191

§ 371 Date: Jul. 14, 2009

(30) Foreign Application Priority Data
Aug. 10, 2004 (AU) 2004904461

(51) Int. Cl. B60N 2/48; B60N 2/28

(52) U.S. Cl. 297/391; 297/410

(57) ABSTRACT

A headrest (110) for a child safety seat, the safety seat includes a seat body (130) or shell having a plurality of shoulder strap aperture means spaced apart along a back portion (120) of the seat body (130), the headrest (110) adjustable to a plurality of predetermined positions relative to the back portion (120) of the seat body (130) and including a shoulder strap aperture means (115) located along a back section of the headrest (110), wherein on adjustment of the headrest (110) to one of the predetermined positions the shoulder strap aperture means (115) in the headrest (110) aligns with corresponding shoulder strap aperture means in the back portion (120) of the seat.

### FIELD OF THE INVENTION

The present invention relates to child safety seats or restraints for child passengers in vehicles. In a particular form the invention relates to a child safety seat adjustable to accommodate children of different ages.

### BACKGROUND OF THE INVENTION

As young children cannot be safely restrained in a vehicle by a standard seat belt, specialised safety seats or child restraints have been developed to protect a child ranging in age from that of a newborn to that of a toddler in the event of an accident. A number of child restraints or safety seats have been developed which are designed to accommodate this wide range of ages in a single unit. Typically these seats can be configured in either the prone configuration suitable for a rearward facing installation or the forward facing upright configuration. In this manner, a single safety seat can be used for both a baby (prone configuration) and a large toddler (forward facing configuration) thereby saving on unnecessary expense.

As well as the necessary pivoting and attachment arrangements which support the ability to configure the child restraint in either the prone or upright position, it is clear that the dimensions of the actual seat section which supports the child must be capable of adjustment to also accommodate the growth of the child. To provide this mode of adjustment, a number of arrangements have been developed including the use of a removable insert which sits within the seat and provides extra support to an infant, to complicated adjustment mechanisms whereby the headrest portion of the seat forms a separate section to the seat body and is adjustable vertically by a complicated gearing arrangement to expand or contract the length of the back portion of the seat.

As is well-known, it is extremely important to provide adequate support to the head, neck and shoulders of a child occupying a restraint as these can be potentially forced sideways and clear of the seat in the event of a side impact to the vehicle. Unfortunately removable inserts as described above can be easily misplaced and furthermore do not effectively adjust the length of the seat. As for those seats that include complicated gearing arrangements and the like to adjust the headrest, these are expensive to produce and also often difficult to adjust.

In addition, as the headrest portion of the seat often includes side wings which further support the child's head, the position of the shoulder straps may need to be varied with respect to the position of these wings as a child's shoulders increase in width as they grow resulting in their shoulders not comfortably fitting between the support wings of the headrest.

It is an object of the present invention to provide an adjustment mechanism for a child safety seat or child restraint capable of accommodating occupants of varying age and size.

It is a further object of the present invention to provide an adjustment mechanism for a child safety seat or child restraint capable of being adjusted to accommodate various seat configurations.

### SUMMARY OF THE INVENTION

In a first aspect the present invention accordingly provides a headrest for a child safety seat, said safety seat including a seat body or shell having a plurality of shoulder strap aperture means spaced apart along a back portion of said seat body, said headrest adjustable to a plurality of predetermined positions relative to said back portion of said seat body and including a shoulder strap aperture means located along a back section of said headrest, wherein on adjustment of said headrest to one of said predetermined positions said shoulder strap aperture means in said headrest aligns with a corresponding shoulder strap aperture means in said back portion of said seat.

Clearly this arrangement provides a convenient and easily adjustable means to change the dimensions of the seat to accommodate children of varying sizes.

Preferably, the headrest includes a plurality of shoulder strap aperture means spaced apart along said back section of said headrest, wherein on adjustment of said headrest to one of said predetermined positions at least one of said shoulder strap aperture means in said headrest aligns with at least one corresponding shoulder strap aperture means in said back portion of said seat.

This allows the positioning of the shoulder straps to be adjusted relative to both the overall height of the headrest and also relative to the wings of the headrest thereby providing a further level of adjustment resulting in increased support for the neck, head and shoulders of an occupant of the seat.

Preferably, the back section of said headrest and said back portion of said seat body are substantially planar and include co-operating sliding means to allow said headrest to slide along said back portion.

Preferably, the sliding means includes a plurality of detent positions, said detent positions corresponding to said predetermined positions wherein said shoulder strap aperture means align.

Preferably, the shoulder strap aperture means includes a pair of spaced apart slots, each slot arranged to receive a corresponding shoulder strap.

Preferably, said safety seat includes anchoring means located at the rear of said seat portion of said seat body, said anchoring means having attachment portions to removably attach a pair of shoulder straps following insertion of said shoulder straps through said respective spaced apart slots located on said headrest and said back portion.

Preferably, said safety seat includes locking means to lock or clamp the position of said headrest with respect to said back portion.

Preferably, said safety seat is configurable to either a generally prone position or alternatively to a generally upright configuration.

In a second aspect the present invention accordingly provides a child safety seat including:
a seat body or shell having a plurality of shoulder strap aperture means spaced apart along a back portion of said seat body,
a headrest adjustable to a plurality of predetermined positions relative to said back portion of said seat body and including a shoulder strap aperture means located along a back section of said headrest, wherein on adjustment of said headrest to one of said predetermined positions said shoulder strap aperture means in said headrest aligns with a corresponding shoulder strap aperture means in said back portion of said seat.

### BRIEF DESCRIPTION OF THE DRAWINGS

A preferred embodiment of the present invention will be discussed with reference to the accompanying drawings wherein:

FIG. 1 is a top perspective view of a partially disassembled child restraint including an adjustable headrest according to a preferred embodiment of the present invention;

FIG. 2 is a rear view of the child restraint illustrated in FIG. 1;

FIG. 3 is a top view of the child restraint illustrated in FIG. 1 fully assembled and in the rearward facing prone position with the headrest in the bottom position and shoulder straps inserted through the lowest pair of slots in the headrest;

FIG. 4 is a side view of the child restraint illustrated in FIG. 3;

FIG. 5 is a top view of the child restraint illustrated in FIG. 3 with shoulder straps inserted through the middle pair of slots in the headrest;

FIG. 6 is a top view of the child restraint illustrated in FIG. 5 with the headrest raised to a first intermediate position;

FIG. 7 is a front view of the child restraint illustrated in FIG. 1 in the upright position with the headrest raised to a second intermediate position and shoulder straps inserted through the bottom pair of slots in the headrest;

FIG. 8 is a front view of the child restraint as illustrated in FIG. 7 with the headrest raised to the top position; and

FIG. 9 is a rear view of the child restraint as illustrated in FIG. 8 depicting the shoulder strap attachment arrangement.

In the following description, like reference characters designate like or corresponding parts throughout the several views of the drawings.

### DESCRIPTION OF PREFERRED EMBODIMENT

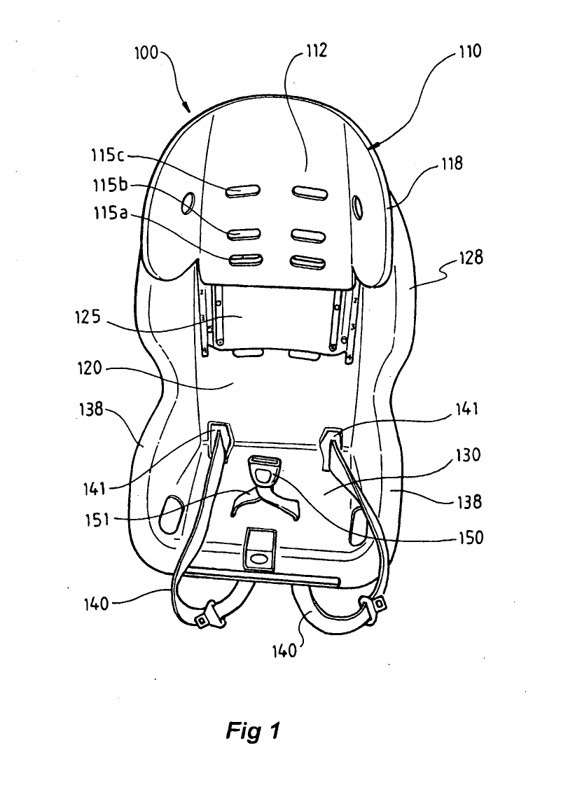

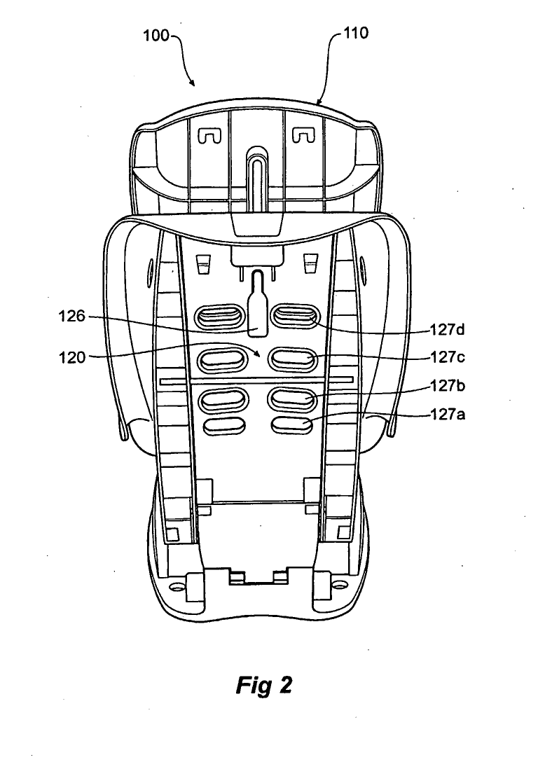

Referring now to FIGS. 1 and 2, there is shown a partially disassembled child restraint 100 in the generally upright forward facing seated position according to a preferred embodiment of the present invention. For clarity, the various padded cushions and overlays have been removed. Child restraint 100 is formed from a moulded plastic material and includes a seat body or shell having a seat portion 130 and a substantially planar elongate back portion 120. Seat portion 130 includes upright side regions 138. Similarly, back portion 120 includes side protrusions 128 which are integrally formed with side regions 138 which together function to limit the range of movement of an occupier of the seat. Attached to seat portion 130 by anchor strap 151 is a buckle 150 for securing the occupant of the seat.

Back portion 120 includes a moulded slide arrangement 125 upon which headrest 110 is able to slide vertically from a lowered position to a raised position. In this embodiment headrest 110 slides to four detent positions corresponding to bottom, first intermediate, second intermediate and top positions. As would be apparent to those skilled in the art, any number of arrangements could be used to provide for relative vertical movement of headrest 110 to back portion 130. Shoulder straps 140 are attached to anchor points 141 at each bottom corner of back portion 130. Back portion 130 also includes four pairs of generally horizontally disposed slots 127a-127d that are vertically spaced with respect to each other (as best seen in FIG. 2). Back portion 130 also includes clamping device 126 which functions to lock the position of headrest 110 in the desired position.

Headrest 110 includes three pairs of generally horizontally disposed slots 115a-115c that are spaced apart vertically along a substantially planar back section 112 of headrest 110. When assembled, shoulder straps 140 are threaded through one of the pair of slots 115a-115c in headrest 110 and furthermore through a corresponding pair of slots selected from 127a-127d in back portion 130 that are aligned with the pair of slots in the headrest. As would be appreciated by those skilled in the art, other types of apertures or aperture means which permit the insertion of shoulder straps are contemplated to be within the scope of the invention. Headrest 110 also includes a pair of side support wings 118 which after fitting of the appropriate padded overlays (not shown) function to support the neck and head regions of an occupier of the child restraint. This is especially important for a very young infant who lacks the necessary muscular strength and control to support their head. Additionally, in the event of an accident, side support wings 118 prevent the head of the occupant from moving outside the confines of the safety seat.

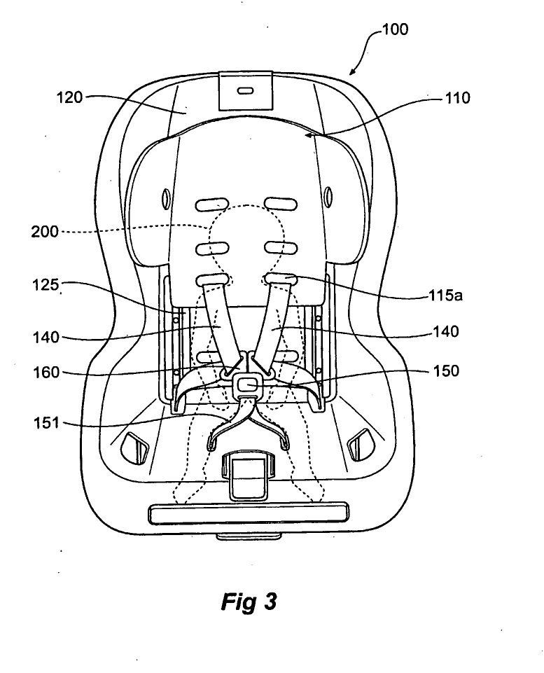

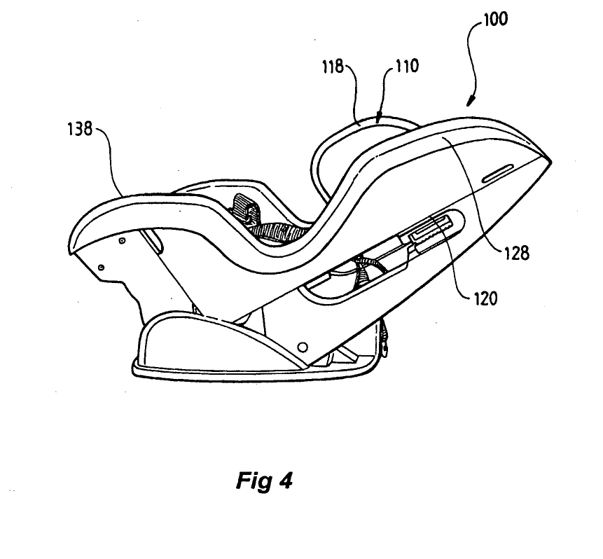

Referring now to FIGS. 3 and 4, there is shown top and side views of the preferred embodiment of the present invention configured in the rearward facing prone position as would be suitable for a very small infant 200. As depicted in FIG. 4, a child restraint would be secured in the rear passenger seat of a vehicle which would be moving to the right of picture. Headrest 110 is locked in bottom position and shoulder straps 140 inserted through a pair of slots 115a in headrest 110 and a corresponding pair of slots 127a (refer to FIG. 2) in back portion 120. As can be seen in this fully assembled state, shoulder straps 140 include tongue elements 160 which are inserted and locked into buckle 150 thereby securing the seat occupant. As would be appreciated by those skilled in the art, the shoulder strap retainment and retraction mechanism can be any of those widely used in the manufacture of child safety seats and is not essential to the working of the invention. In this configuration, child restraint 100 is suitable to support and protect a newborn infant whose shoulders will be located below slots 115a thereby resulting in headrest 110 providing effective support to the head and neck.

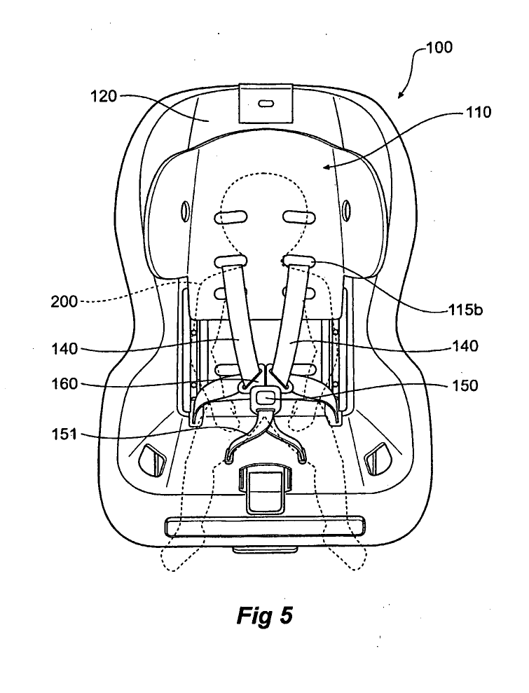

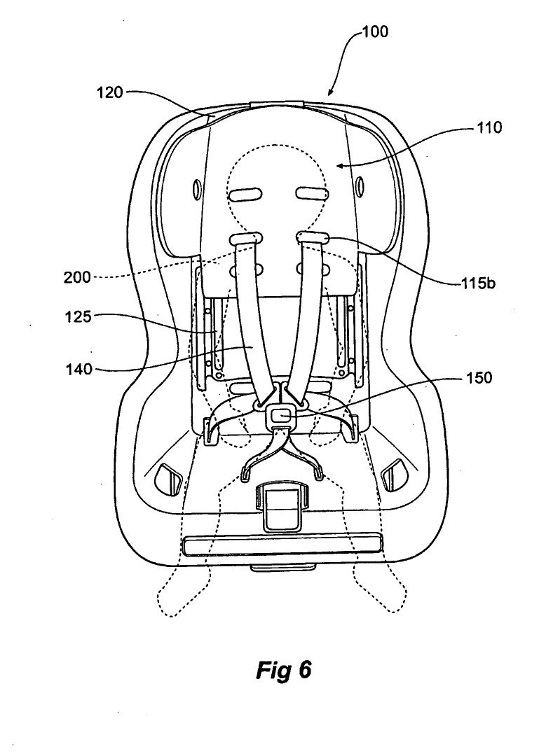

Referring now to FIG. 5, there is shown the child restraint illustrated in FIG. 4 configured for a slightly larger infant 200 wherein shoulder straps 140 are inserted into a pair of slots 115b in headrest 110 and a corresponding pair of slots 127b (refer to FIG. 2) in back portion 120. As the infant will have increased in length this modification ensures that shoulder straps 140 comfortably fit over the shoulders of the infant. As shown in FIG. 6, child restraint 100 can be further adjusted in the prone position as the infant 200 increases in size. In this example, headrest 110 is raised to the first intermediate position from the bottom position with shoulder straps 140 being inserted through a pair of slots 115b in the headrest 110 and a corresponding pair of slots 127c in back portion 120 (refer to FIG. 2), once again ensuring that the shoulder straps 140 comfortably fit over the shoulders of the infant and ensuring that the head and neck are effectively. supported by headrest 110.

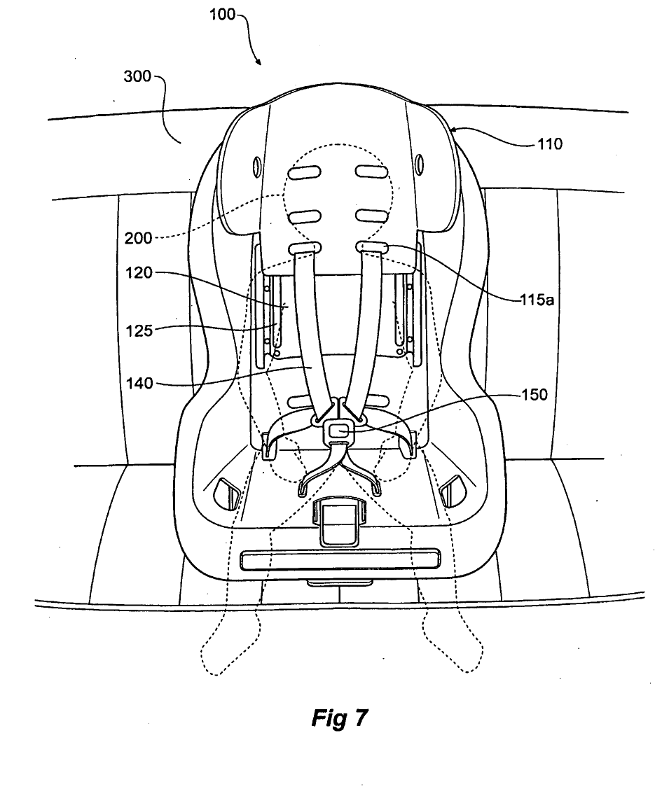

Referring now to FIG. 7, there is shown child restraint 100 as positioned on a car seat 300 in the generally upright and forward facing configuration as would be suitable for a toddler 200. Headrest 110 is raised to the second intermediate position and shoulder straps 140 are inserted through a bottom pair of slots 115a in headrest 110 and a corresponding pair of slots 127c. Generally the shoulders of a toddler of this size will not fit between side support wings 118, so the shoulder straps will commonly be inserted in the bottom pair of slots 115a. However, as would be appreciated by those skilled in the art, the present invention allows for those circumstances where an infant may be unusually long and require the shoulder straps to be inserted through a pair of slots 115b to provide adequate head and neck support.

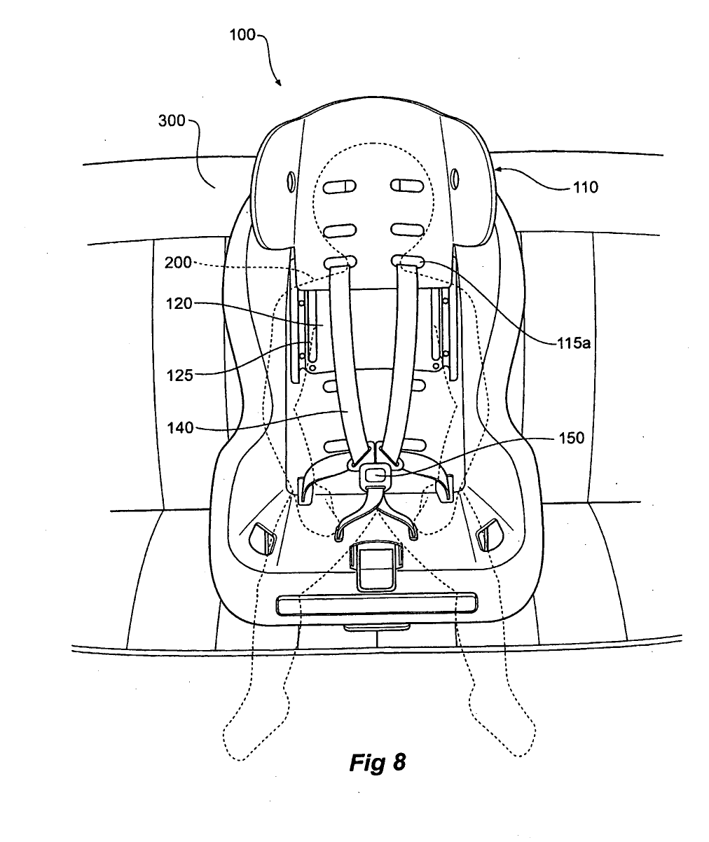

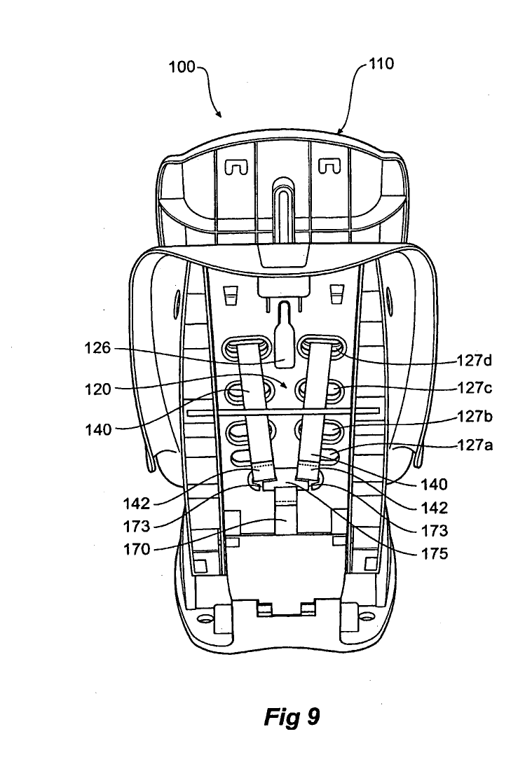

Referring now to FIGS. 8 and 9, there are shown front and rear views of child restraint 100 as configured for the maximum size of seat occupant with headrest 110 located in top position and shoulder straps inserted through a pair of slots 115a in headrest 110 and a corresponding pair of slots 127d in back portion 120. In FIG. 9 there is shown the retaining arrangement for shoulder straps 140 which includes a retractable anchor strap or belt 170 which can be locked at various positions and which is permanently attached to bracket 175. Shoulder strap ends 142 are removably attached to bracket 175 by looping over slotted sections 173 located on bracket 175. Due to the retraction of anchor strap 170 downwards the shoulder straps 140 can be adjusted to the correct tightness and then locked in place.

A brief consideration of the above described embodiment will indicate that the invention provides an extremely simple, economical means to adjust the configuration of a child safety seat or restraint to accommodate a growing infant.

Whilst this preferred embodiment has been discussed in the context of a child restraint that can be configured to either a generally prone or upright configuration it is clear that the adjustment mechanism described herein may be equally applied to those child safety seats or restraints which are sole purpose in that they are either suitable for a young infant or a toddler.

Although a preferred embodiment of the present invention has been described in the foregoing detailed description, it will be understood that the invention is not limited to the embodiment disclosed, but is capable of numerous rearrangements, modifications and substitutions without departing from the scope of the invention as set forth and defined by the following claims.

1. A headrest for a child safety seat, said safety seat including a seat body or shell having a plurality of shoulder strap aperture means spaced apart along a back portion of said seat body, said headrest adjustable to a plurality of predetermined positions relative to said back portion of said seat body and including a shoulder strap aperture means located along a back section of said headrest, wherein on adjustment of said headrest to one of said predetermined positions said shoulder strap aperture means in said headrest aligns with a corresponding shoulder strap aperture means in said back portion of said seat.

2. A headrest for a child safety seat as claimed in claim 1, wherein said headrest includes a plurality of shoulder strap aperture means spaced apart along said back section of said headrest, wherein on adjustment of said headrest to one of said predetermined positions at least one of said shoulder strap aperture means in said headrest aligns with at least one corresponding shoulder strap aperture means in said back portion of said seat.

3. A headrest for a child safety seat as claimed in claim 1, wherein said back section of said headrest and said back portion of said seat body are substantially planar and include cooperating sliding means to allow said headrest to slide along said back portion.

4. A headrest for a child safety seat as claimed in claim 3, wherein said sliding means includes a plurality of detent positions, said detent positions corresponding to said predetermined positions wherein said shoulder strap aperture means align.

5. A headrest for a child safety seat as claimed in claim 1, wherein said shoulder strap aperture means each includes a pair of spaced apart slots, each slot arranged to receive a corresponding shoulder strap.

6. A headrest for a child safety seat as claimed in claim 5, wherein said safety seat includes anchoring means located at the rear of said seat portion of said seat body, said anchoring means having attachment portions to removably attach a pair of shoulder straps following insertion of said shoulder straps through said respective spaced apart slots located on said headrest and said back portion.

7. A headrest for a child safety seat as claimed in claim 1, wherein said safety seat includes locking means to lock or clamp the position of said headrest with respect to said back portion.

8. A headrest for a child safety seat as claimed in claim 1, wherein said safety seat is configurable to either a generally prone position or alternatively to a generally upright configuration.

9. A child safety seat including:
a seat body or shell having a plurality of shoulder strap aperture means spaced apart along a back portion of said seat body,
a headrest adjustable to a plurality of predetermined positions relative to said back portion of said seat body and including a shoulder strap aperture means located along a back section of said headrest, wherein on adjustment of said headrest to one of said predetermined positions said shoulder strap aperture means in said headrest aligns with a corresponding shoulder strap aperture means in said back portion of said seat.

10. A child safety seat as claimed in claim 9, wherein said headrest includes a plurality of shoulder strap aperture means spaced apart along said back section of said headrest, wherein on adjustment of said headrest to one of said predetermined positions at least one of said shoulder strap aperture means in said headrest aligns with at least one corresponding shoulder strap aperture means in said back portion of said seat.

11. A child safety seat as claimed in claim 9, wherein said back section of said headrest and said back portion of said seat body are substantially planar and include cooperating sliding means to allow said headrest to slide along said back portion.

12. A child safety seat as claimed in claim 11, wherein said sliding means includes a plurality of detent positions, said detent positions corresponding to said predetermined positions wherein said shoulder strap aperture means align.

13. A child safety seat as claimed in claim 9, wherein said shoulder strap aperture means each includes a pair of spaced apart slots, each slot arranged to receive a corresponding shoulder strap.

14. A child safety seat as claimed in claim 13, wherein said safety seat includes anchoring means located at the rear of said seat portion of said seat body, said anchoring means having attachment portions to removably attach a pair of shoulder straps following insertion of said shoulder straps through said respective spaced apart slots located on said headrest and said back portion.

15. A child safety seat as claimed in claim 10, wherein said safety seat includes locking means to lock or clamp the position of said headrest with respect to said back portion.

16. A child safety seat as claimed in claim 10, wherein said safety seat is configurable to either a generally prone position or alternatively to a generally upright configuration.
